(19) United States
(12) Patent Application Publication
(10) Pub. No.: US 2009/0136073 A1
(43) Pub. Date: May 28, 2009

(54) Microphone

(76) Inventors: Ching-Wen Chang, Taichung (TW); Fang-Chang Hsieh, Taichung (TW); Wen-Chieh Wei, Taichung (TW)

Correspondence Address: Muncy, Geissler, Olds & Lowe, PLLC, P.O. BOX 1364, FAIRFAX, VA, 22038-1364, US

(21) Appl. No.: 11/945,295

(22) Filed: Nov. 27, 2007

(51) Int. Cl. H04R 21/02

(52) U.S. Cl. 381/361

(57) ABSTRACT

A microphone having a first shell with a cavity region is disclosed. A PCB and a sound receiving member are mounted within the cavity region. A brace is disposed over the cavity region having opposite ribs located against two opposite sides of the PCB. A push button is operably mounted on the brace and is adapted to be moveably operated to actuate the PCB ON or OFF.

### BACKGROUND OF THE INVENTION

1. Field of the Invention

The present invention relates to a microphone for use with a communication device, and more particularly, to a microphone that has a brace for securely holding a printed circuit board thereof in place.

2. Description of the Related Art

Referring to FIGS. 7 and 8, a known microphone 9 includes a first shell 91 having a cavity region with a printed circuit board (PCB) 911 mounted therein and a cord 912 electrically connected with the PCB 911 attached thereto. A brace 92 is mounted over the cavity region of the first shell 91 and on the brace 92 there is mounted a push button 93. The brace 92 includes two transverse orifices 921 formed thereof, and the push button 93 includes two hooks which respectively fit into the orifice 921. A second shell 94 is thereafter disposed over the brace 20 and connects to the first shell 91 such that the brace 20 is accommodated within the first and second shells 93, 94. Furthermore, the second shell 94 includes a transverse cutout hole 941 which allows the push button 93 to expose out of the second shell 94. Thus, a user can touch the push button 93 to actuate the PCB 911 ON or OFF.

The primary problem associated with the microphone 9 is that the first shell 91 is usually made compact and it is thus difficult to securely attach the PCB 911. Thus if a user pulls the cord 912 accidentally, the PCB 911 may be jolted upward toward and then mis-actuated by the push button 93 by such a sudden force.

The present invention is, therefore, intended to obviate or at least alleviate the problems encountered in the prior art.

### SUMMARY OF THE INVENTION

It is an object of the present invention to provide a microphone that prevents a PCB therein from being jolted and then mis-actuated while still remaining in a compact structure.

It is also object of the present invention to provide a microphone that has a push button stably fixed thereto and stably operably moveable.

Accordingly, the present invention discloses a microphone comprising a first shell having a cavity region. A PCB and a sound receiving member are mounted within the cavity region. A brace is disposed over the cavity region having opposite ribs located against two opposite sides of the PCB. A push button is operably mounted on the brace and is adapted to be moveably operated to actuate the PCB ON or OFF.

The brace comprises two orifices, and the push button has two hooks inserted into the orifices respectively. The brace further comprises two opposite protrusions formed adjacent at each orifice such that each hook is moved between two protrusions when push button is moveably operated. Additionally, a cross member extends between the two protrusions and each hook is stably engagable thereto.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of a microphone in accordance with the present invention.

FIG. 2 is an exploded perspective view of the microphone.

FIG. 3 is a cross-sectional view taken along a line 3-3 in FIG. 1.

FIG. 4 is a cross-sectional view taken along a line 4-4 in FIG. 3.

FIG. 5 is a cross-sectional view taken along a line 5-5 in FIG. 3.

FIG. 6 is similar to FIG. 5, but showing the actuation of the microphone.

FIG. 7 is an exploded perspective view of a conventional microphone

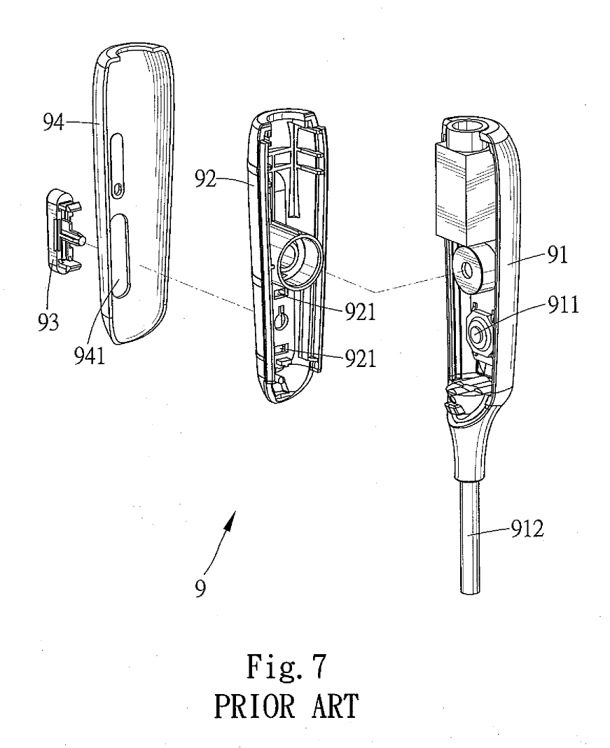

FIG. 8 is a cross-sectional view of the microphone in FIG. 7

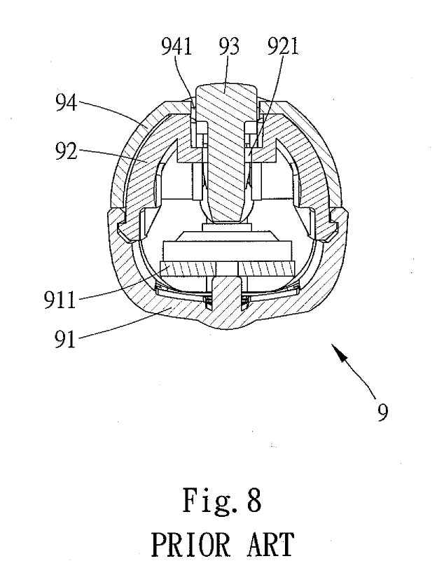

### DETAILED DESCRIPTION OF THE PREFERRED EMBODIMENT

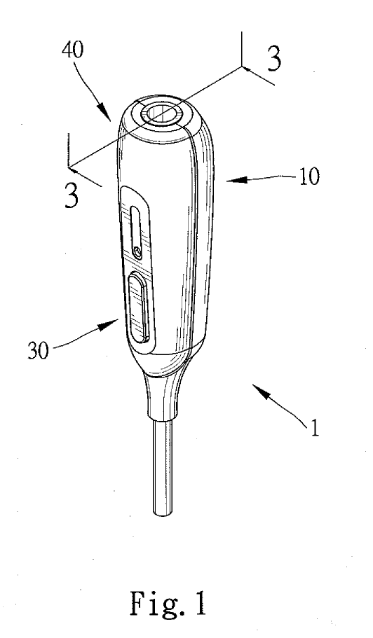

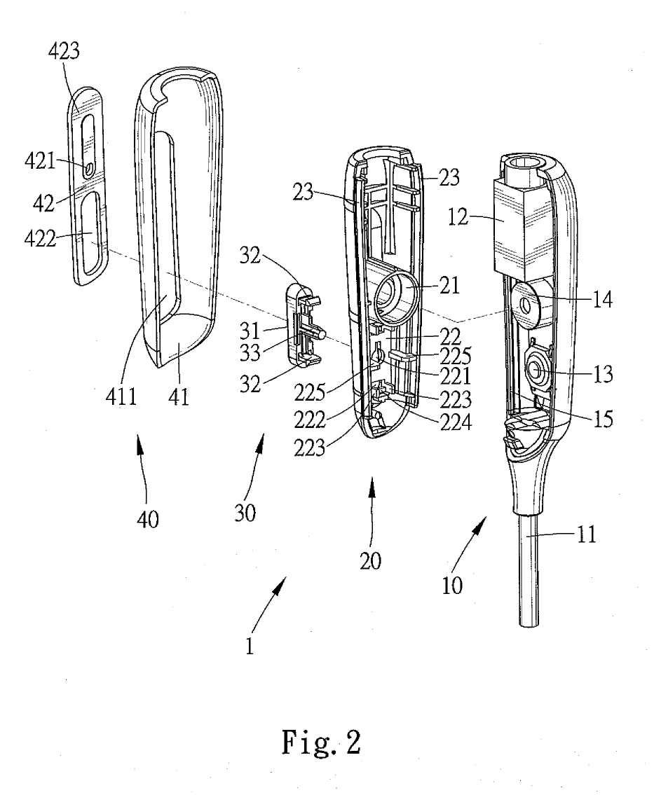

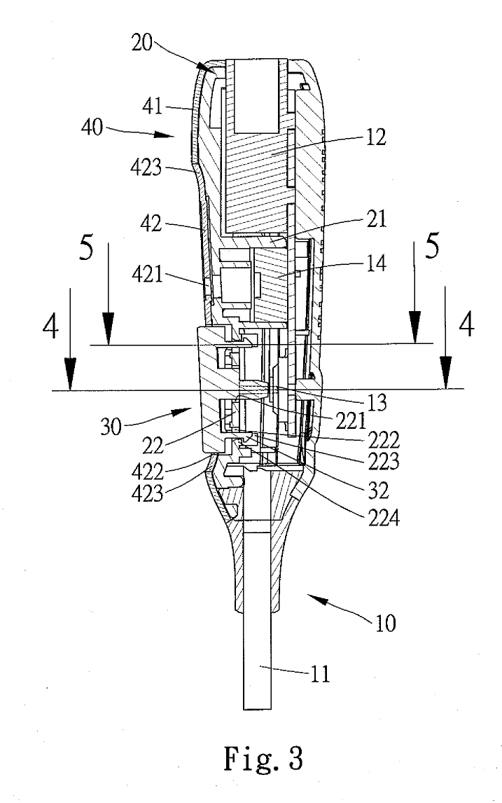

Referring to FIGS. 1 through 3, a microphone 1 in accordance with the present invention comprises a first shell 10 having a rear wall, side walls and a cavity region extending between the side walls. The first shell 10 further comprises clipping portions 15 thereon which extends on the side walls respectively. Additionally, a printed circuit board (PCB) 13, a socket 12 for receiving an earphone plug (not shown) and a sound receiving member 14 is mounted in the cavity region. Further, a cord 11 is attached to the first shell 10 and has an end electrically connected with the PCB 13.

A brace 20 is disposed over the cavity region and includes side walls and a rear wall 22 extending between the side walls. A clipping portion 23 is formed on each side wall and is complemently engagable with the associated clipping portion 15 of the first shell 10. A position limiter 21 is formed on the rear wall 22 and is provided for retaining the sound receiving member 14 in position. In this embodiment, the position limiter 21 is of a configuration which has a wall radially surrounds the sound receiving member 14. Moreover, two ribs 225 are formed on the side walls respectively.

A push button 30 is operably mounted on the brace 20. The push button 30 includes a first side having a protuberance 33 and two hooks 32 equally spaced from the protuberance 33. The protuberance 33 is insertable through a hole 221 disposed between the ribs 225, and the hooks 32 are insertable through respective offices 222 and moveable between two oppositely disposed protrusions 223 and engagable with a respective cross member 224 extending between the protrusions 223. As a result, the push button 30 is prevented from disengaging from the brace 20. The push button 30 further includes a pressing face 31 formed at a second side thereof.

A second shell 40 is disposed over the brace 20 and includes a first body 41 engaged with the first shell 10 and a second body 42 complemently received in a cutout hole 411 formed on the first body 41. In addition, the second body 42 has a sound aperture 421 communicating with the sound receiving member 14 and an opening 422 which allows the push button 30 to expose out of the second shell 40

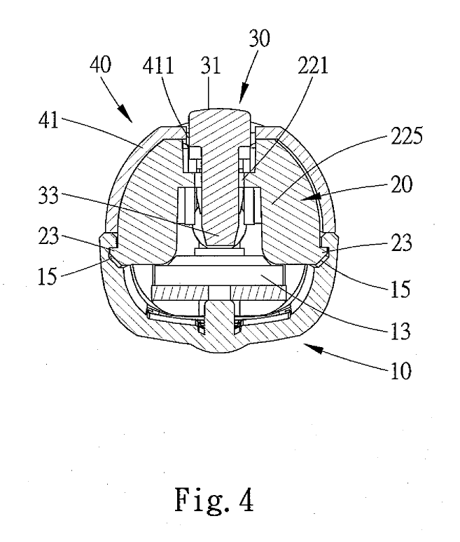

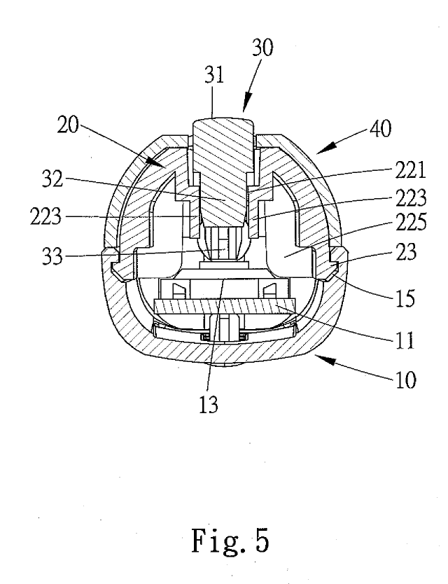

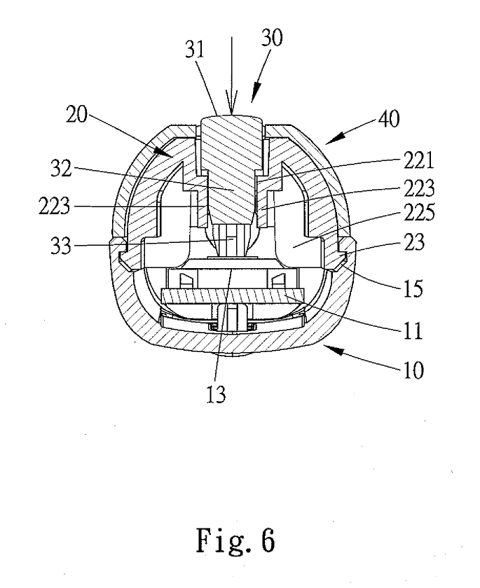

Referring to FIGS. 4 and 5, the push button 30 is stably retained on the brace 20, the hooks 32 are held by the cross members 224 respectively, and each hooks 32 is supported between two respective protrusions 223 in such a manner that the push button 30 is restrained from sideway movement. Additionally, the ribs 225 are located against two opposite sides of the PCB 13 such that the PCB 13 is restrained from movement and inhibited from being mis-actuated by the push button 30 in case a user pulls the cord 11 accidentally. As also best seen in FIG. 6, the push button 30 is pressed at the pressing face 31, the protuberance 33 are next operably moved to press the PCB 13, therefore actuating the PCB 13 ON or OFF. Additionally, the hooks 32 are operably moved between the respective protrusions 223.

While the specific embodiments have been illustrated and described, numerous modifications come to mind without significantly departing from the spirit of invention and the scope of invention is only limited by the scope of accompanying claims.

What is claimed is:

1. A microphone comprising:
a first shell having a cavity region;
a PCB and a sound receiving member mounted within the cavity region;
a brace, disposed over the cavity region, having opposite ribs located against two opposite sides of the PCB;
a push button operably mounted on the brace, for being moveably operated to actuate the PCB ON or OFF.

2. The microphone as claimed in claim 1, wherein the brace comprises two orifices, and the push button has two hooks inserted into the orifices respectively, and the brace further comprises two opposite protrusions formed adjacent at each orifice, and each hook is supported in a manner that the push button is restrained from sideway movement while being moved between two protrusions when push button is moveably operated.

3. The microphone as claimed in claim 2, wherein the brace further comprises a cross member extending between the two protrusions, and the hook is stably engagable with the cross member.

4. The microphone as claimed in claim 1, wherein the first shell comprises a first clipping portion formed thereon, and the brace comprises a second clipping portion complemently engagable with the first clipping portion of the first shell.

5. The microphone as claimed in claim 1, wherein the brace further comprises a position limiter at a position corresponding to the sound receiving member for retaining the sound receiving member in position.

6. The microphone as claimed in claim 1, further comprising a second shell, disposed over the brace, having a first body with a cutout hole and a second body complemently received in the cutout hole.

7. The microphone as claimed in claim 6, wherein the second shell further comprises a sound aperture communicating with the sound receiving member and an opening that allows the push button to expose out of the second shell.

8. The microphone as claimed in claim 6, wherein the first and second bodies are made of aluminum.
